(19) United States
(12) Patent Application Publication
(10) Pub. No.: US 2016/0370833 A1
(43) Pub. Date: Dec. 22, 2016

(54) Electrical Appliance Administration System

(71) Applicant: Taiwan Intelligence Service Company Ltd., Hsinchu City (TW)

(72) Inventors: Wen-Tse Lu, Hsinchu City (TW); Chin-Hui Hung, Hsinchu City (TW)

(21) Appl. No.: 14/740,319

(22) Filed: Jun. 16, 2015

(51) Int. Cl. G06F 1/26; H04L 29/08

(52) U.S. Cl. CPC G06F 1/266; H04L 67/1002

(57) ABSTRACT

An electrical appliance administration system is provided. The electrical appliance administration system includes at least one power control device, a cloud server and a portable electronic device. The power control device is configured to connect to an electrical appliance. The power control device includes a control module and a power measurement unit. The power measurement unit is configured to detect a power data of the electrical appliance. The power measurement unit is configured to transmit the power data to the cloud server. The portable electronic device includes a power management program. When the power management program is operated, the portable electronic device would be connected to the cloud server, and the power data will be downloaded to the power management program.

### FIELD OF THE INVENTION

The present invention relates to an electrical appliance administration system, more particularly to an electrical appliance administration system having a cloud server.

### BACKGROUND OF THE INVENTION

In general, people in the house usually use lots of the electrical appliances such as televisions, computers, air conditionings and electronic pots, etc. However, while these electrical appliances are in the standby state, some electrical appliances would still consume power, and the power consumed is not easy to be noticed in our daily life. In addition, when a plurality of the high-wattage electrical appliances is plugged into the same power strip, the electrical load would exceed the available electrical power easily. As a result, exceeding the available electrical power would cause the wire of the power strip burned. Therefore, the security of house is in great peril.

Moreover, if members of the family leave the house and forget to turn off an electrical appliance (e.g., air conditioning) being used, the electrical appliance not only will reduce its life performance but also will waste energy. In addition, when there are some young children in the family, the young children might turn on some dangerous electrical appliances (e.g., microwave oven, oven, or washing machine) because of curiosity. If adults and young children of the members of the family are not in the same space (e.g., the adults are in the living room and the young children are in the kitchen), the adults cannot perceive whether the dangerous electrical appliances are turned on by the young children. Therefore, the young children might be injured due to the dangerous electrical appliance.

Therefore, how to improve the above problems is worth considering to a person having ordinary skills in the art.

### SUMMARY OF THE INVENTION

An electrical appliance administration system is provided. The electrical appliance administration system could prevent the energy from being wasted. Furthermore, when the electrical appliance in the house is turned on, the electrical appliance administration system would transmit a message to warn the user immediately. The electrical appliance administration system allows a plurality of users to administer the electrical appliance and receive the message. The electrical appliance administration system allows the user to plan a schedule of using the electrical appliance.

An electrical appliance administration system is provided. The electrical appliance administration system includes at least one power control device, a cloud server and a portable electronic device. The power control device is configured to connect to an electrical appliance and to receive a power provided by an external power. Afterward, the power control device is configured to transmit the power to the electrical appliance. The power control device includes a control module and a power measurement unit. The power measurement unit is configured to detect a power data of the electrical appliance. The power measurement unit is configured to transmit the power data to the cloud server. The portable electronic device includes a power management program. The power management includes a display interface. When the power management program is operated, the portable electronic device would be connected to the cloud server, and the power data will be downloaded to the power management program.

In the electrical appliance administration system, the power control device includes a control module, and the control module can turn on and turn off the power control device.

In the electrical appliance administration system, the display interface includes a power control switch; when the control switch is turned off, the power management program would transmit a turn off-control signal to the cloud server. And then, the cloud server would transmit the turn off-control signal to the power control device. The control module turns off the power control device depending on the off-control signal.

In the electrical appliance administration system, when the cloud server receives the power data, the cloud would transmit a first notification message to the portable electronic device.

In the electrical appliance administration system, the power data is a value of an electric power.

In the electrical appliance administration system, when the value of the electric power received by the cloud server is more than a wattage value, the cloud server would transmit a second notification message to the portable electronic device.

In the electrical appliance administration system, the power control device is a smart plug.

In the electrical appliance administration system, the portable electronic device is a smart phone or a tablet PC.

In the electrical appliance administration system, the electrical appliance administration includes a secondary portable electronic device. The secondary portable electronic device includes a secondary power management program. The secondary power management program saves a piece of identity information, and the power management program comprising an authorization interface. When the authorization interface is inputted with the identity information, the power data of cloud server would be downloaded to the secondary power management program.

In the electrical appliance administration system, the identity information is personal mobile phone number or personal E-mail address.

An electrical appliance administration system is provided. The electrical appliance administration system includes at least one electrical appliance, a cloud server and a portable electronic device. The electrical appliance includes power measurement unit and a Wi-Fi module. The power measurement unit is configured to detect a power data of the electrical appliance. The Wi-Fi module wirelessly transmits the power data to the cloud server. In addition, the portable electronic device includes a power management program, and the power management program includes a display interface. When the power management program is operated, the portable electronic device is connected to the cloud server, and the power data would be downloaded to the power management program.

In the electrical appliance administration system, when the cloud server receives the power data, the cloud would transmit a first notification message to the portable electronic device.

In the electrical appliance administration system, when the value of the electric power received by the cloud server is more than a wattage value, the cloud server would transmit a second notification message to the portable electronic device.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A illustrates a block diagram of an electrical appliance administration system in accordance with an embodiment of the present invention;

FIG. 1B illustrates a block diagram of an electrical appliance administration system comprising a plurality of power control devices in accordance with an embodiment of the present invention;

FIG. 2 illustrates a schematic diagram of the power control device;

FIG. 3 illustrates a schematic diagram of a power management program used on a portable electronic device;

FIG. 4 illustrates a schematic diagram of a second notification message displayed on the portable electronic device.

FIG. 5 illustrates a schematic diagram of a first notification message displayed on the portable electronic device.

FIG. 6 illustrates a block diagram of the electrical appliance administration system in accordance with another embodiment of the present invention;

FIG. 7 illustrates a schematic diagram of the power management program;

FIG. 8 illustrates a block diagram of the electrical appliance administration system in accordance with another embodiment of the present invention;

FIG. 9 illustrates a schematic diagram of an authorization interface; and

FIG. 10 illustrates a block diagram of the electrical appliance administration system in accordance with another embodiment of the present invention.

### DETAILED DESCRIPTION OF PREFERRED EMBODIMENTS

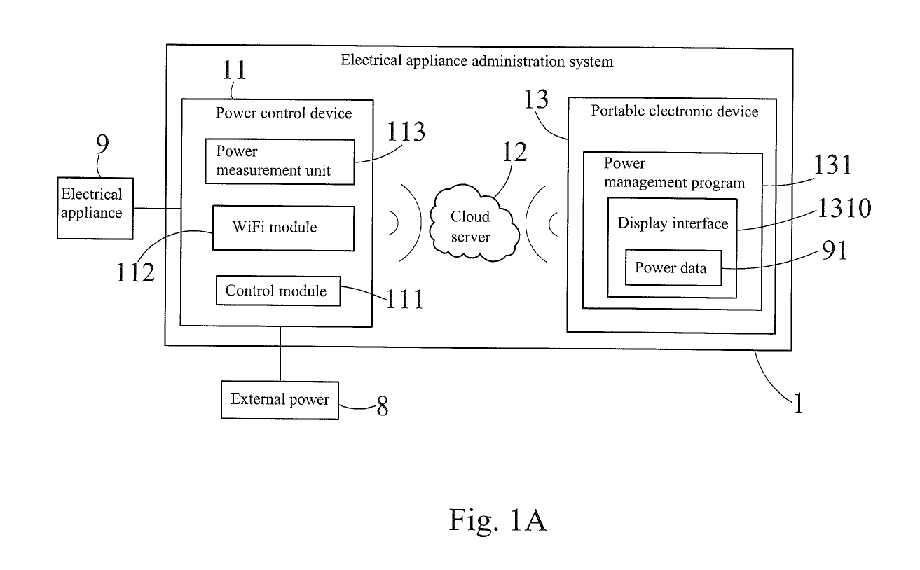

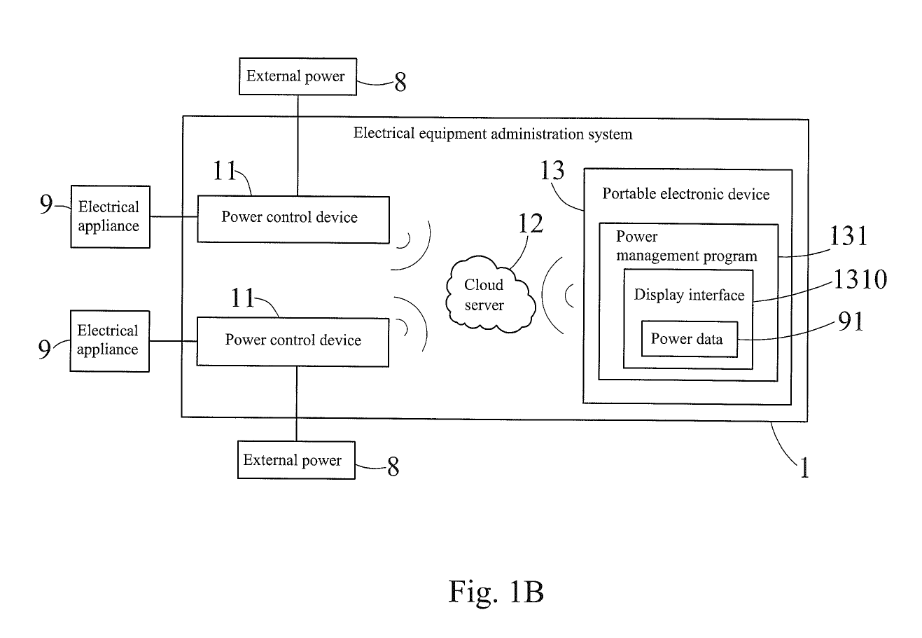

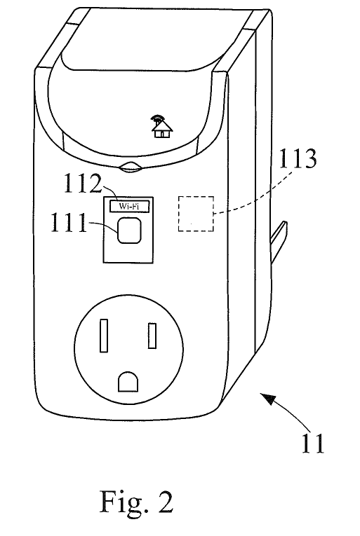

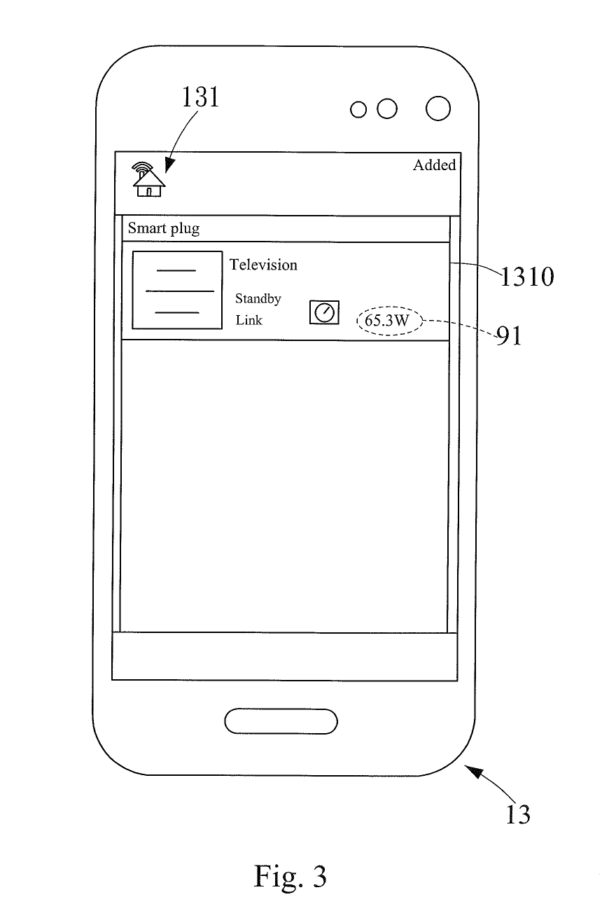

Please refer to FIG. 1A and FIG. 1B. FIG. 1A illustrates a block diagram of an electrical appliance administration system 1 in accordance with an embodiment of the present invention. FIG. 1B illustrates a block diagram of an electrical appliance administration system 1 comprising a plurality of power control devices 11 in accordance with the embodiment of the present invention. The electrical appliance administration system 1 includes at least one power control device 11, a cloud server 12, and a portable electronic device 13. Please refer to FIG. 2. FIG. 2 illustrates a schematic diagram of the power control device 11. The power control device 11 for example is a smart plug. The power control device 11 is connected to an electrical appliance 9. The electrical appliance 9 for example is a television, a computer, an air conditioning, a microwave oven, an oven, or a washing machine, etc. In addition, the power control device 11 includes a control module 111, a Wi-Fi module 112, and a power measurement unit 113. The power control device 11 is configured to receive a power provided by an external power 8 and to transmit the power to the electrical appliance 9. The control module 111 is configured to turn on and turn off the power control device 11. Moreover, the power measurement unit 113 is configured to detect a power data 91 of the electrical appliance 9. The power data 91 for example is a value of an electric power (the unit of the electric power is watt). Afterward, the Wi-Fi module 112 of the power control device 11 is configured to transmit the power data 91 to the cloud server 12. Please refer to FIG. 3. FIG. 3 illustrates a schematic diagram of a power management program 131 used on a portable electronic device 13. The portable electronic device 13 for example is a smart phone or a tablet PC. The portable electronic device 13 includes a power management program 131. The power management program 131 includes a display interface 1310. When the power management program 131 is operated, the portable electronic device 13 is connected to the cloud server 12, and the power data 91 would be downloaded to the power management program 131. Afterward, the power data 91 would be displayed on the display interface 1310. For example, the power control device 11 is connected to a television (not illustrated), and if the television is turned on, the power measurement unit 113 is configured to detect a value (e.g., 65.3 W) of the electric power of the television immediately. Afterward, the power control device 11 is configured to transmit the value (e.g., 65.3 W) of the electric power to the cloud server 12. Afterward, when the power management program 131 of the portable electronic device 13 is operated, the portable electronic device 13 is immediately connected to the cloud server 12, and the value (e.g., 65.3 W) of the electric power would be downloaded to the power management program 131. Afterward, the value (e.g., 65.3 W) of the electric power would be displayed on the display interface 1310 (please refer to FIG. 3 again). As a result, when the electrical appliance 9 is being used, the electrical appliance administration system 1 would make the user with the portable electronic device 13 get the value of the electric power of the electrical appliance 9. When the user gets the value of the electric power of each electrical appliance 9, he can prevent from plugging a plurality of the high-wattage electrical appliances 9 into the same power strip, and also prevent the power strip from burning. From the above, when the electrical appliances 9 are in the standby state, their power consumption would also be displayed on the display interface 1310. Therefore, the user with the portable electronic device 13 becomes aware of the electric power in the standby state. In addition, the electrical appliance administration system 1 in FIG. 1A includes only one power control device 11. However, the electrical appliance administration system 1 in FIG. 1B could also include a plurality of the power control device 11. Each power control device 11 is connected to different type of the electrical appliances 9. As a result, the user could get the power consumption of each electrical appliance 9.

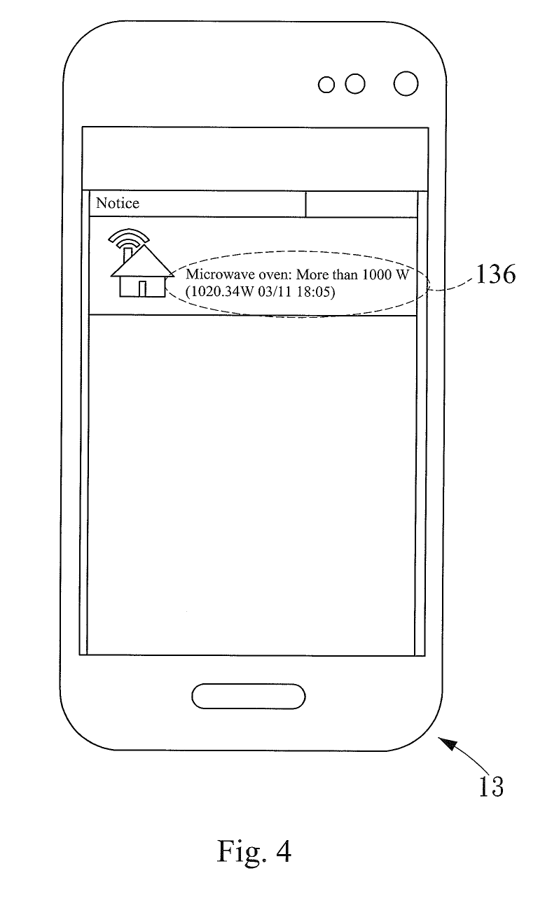

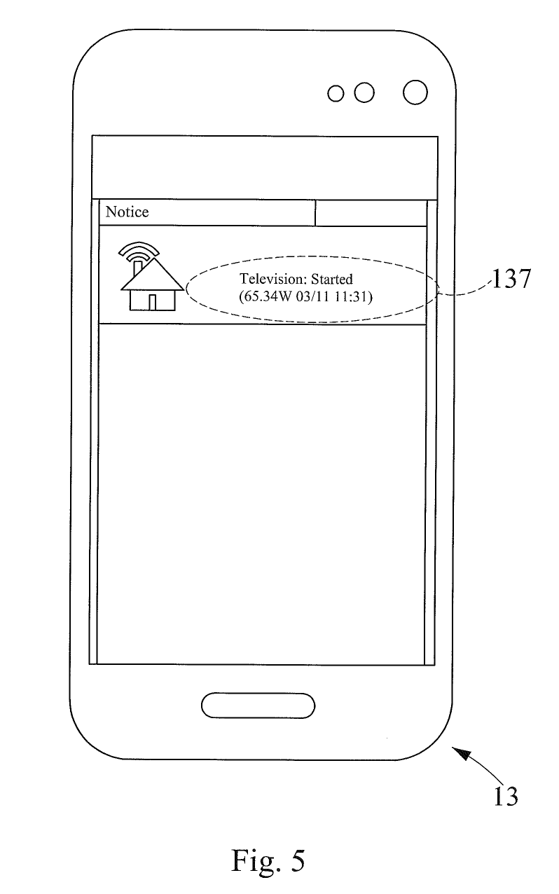

Moreover, please refer FIG. 5. FIG. 5 illustrates a schematic diagram of a first notification message displayed on the portable electronic device. When the power data 91 is received by the cloud server 12, a first notification message 137 is transmitted to the portable electronic device 13 by the cloud server 12. As a result, when the electrical appliance 9 in the house is turned on for no reason (e.g., the young children turn on some dangerous electrical appliances 9), the user with the portable electronic device 13 could perceive that at the first time and increase the safety of using the electrical appliance 9 in the house. Furthermore, please refer FIG. 4. FIG. 4 illustrates a schematic diagram of a second notification message 136 displayed on the portable electronic device. When the value of the electric power received by the cloud server 12 is more than a wattage value (e.g., the wattage value is 1000 W), the cloud server 12 would transmit a second notification message 136 to the portable electronic device 13. As a result, the portable electronic device 13 also reminds the user to pay attention to the high-wattage the electrical appliance 9 being used.

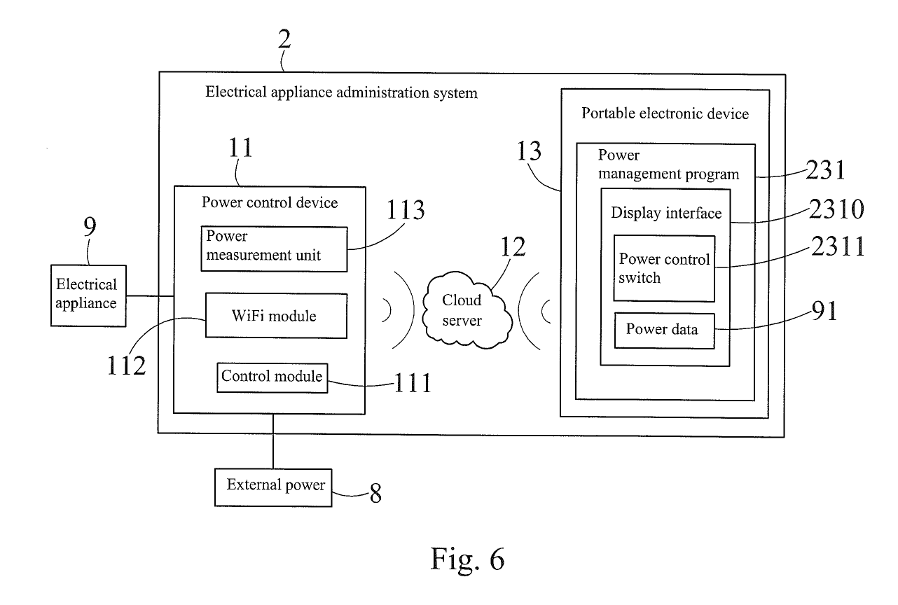

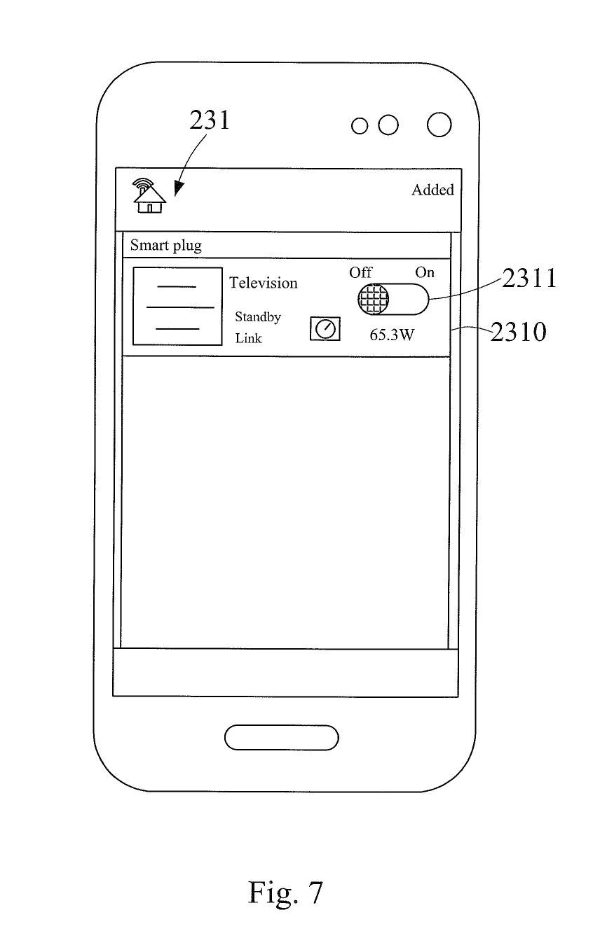

Please refer FIG. 6 and FIG. 7. FIG. 6 illustrates a block diagram of the electrical appliance administration system 2 in accordance with another embodiment of the present invention. FIG. 7 illustrates a schematic diagram of the power management program 231. The electrical appliance . administration system 2 includes all technical features of the electrical appliance administration system 1. In addition, the display interface 2310 of the electrical appliance administration system 2 further includes a power control switch 2311. When the power control switch 2311 is turned off, a turn off-control signal is transmitted to the cloud server 12 by the power management program 231. Afterward, the turn off-control signal is transmitted to the power control device 11 by the cloud server 12, and the control module 111 depends on the turn off-control signal to turn off the power control device 11. Then, the power control device 11 stops transmitting the power to the electrical appliance 9. As a result, when members of the family leave the house and forget to turn off the electrical appliance 9 (e.g., air conditioning) being used, the members can use the power control switch 2311 of the electrical appliance administration system 2 to stop the electrical appliance 9 working and to save energy. By the same token, when the power control switch 2311 is turned on, a turn on-control 1 signal is transmitted to the cloud server 12 by the power management program 231. Moreover, according to the turn off-control 1 signal and the turn on- control 1 signal, the power management program 231 could plan a schedule of using the electrical appliance 9.

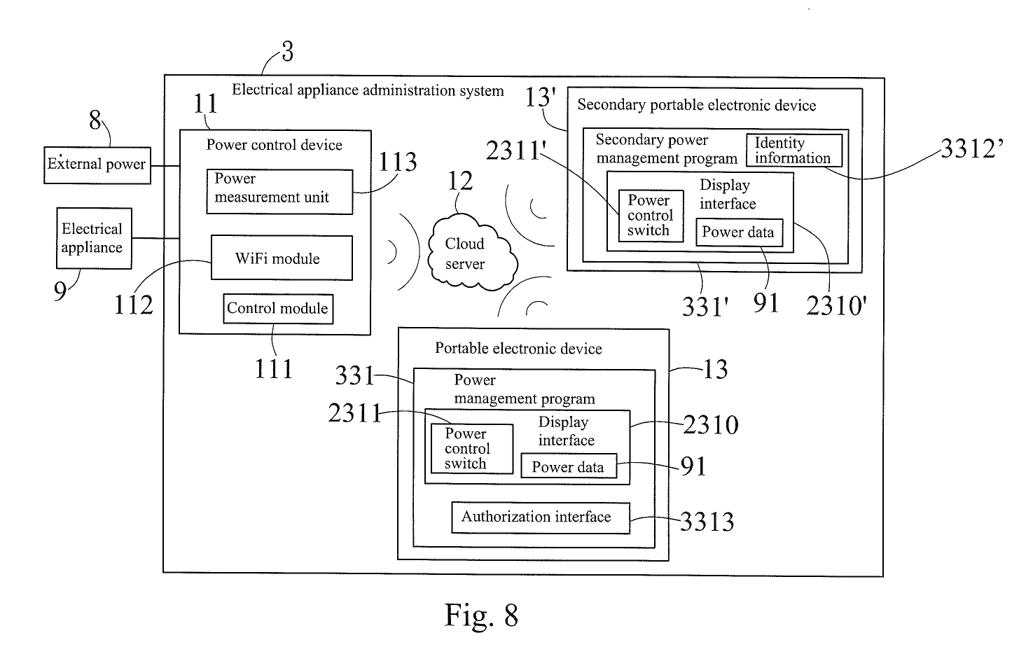

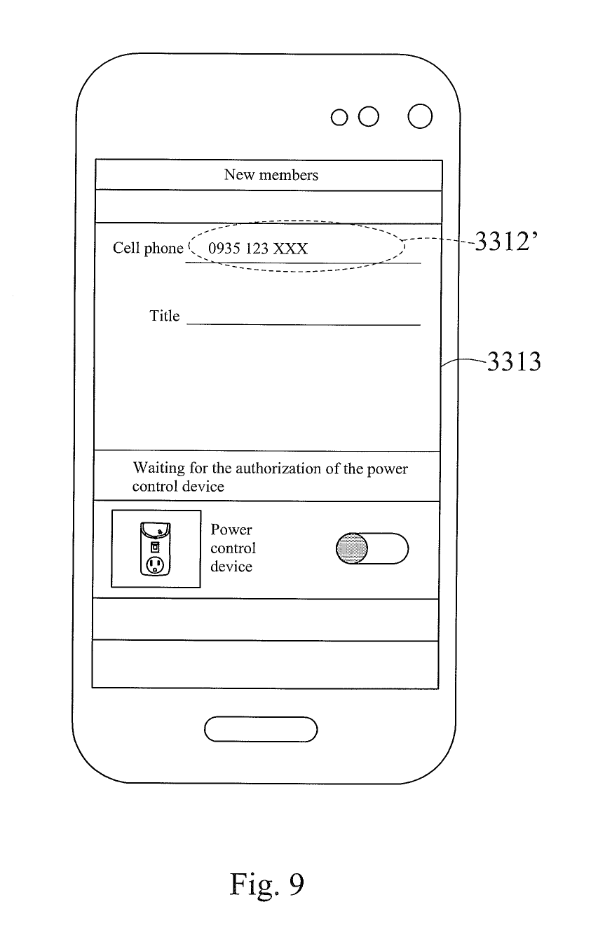

Please refer FIG. 8 and FIG. 9. FIG. 8 illustrates a block diagram of the electrical appliance administration system 3 in accordance with another embodiment of the present invention. FIG. 9 illustrates a schematic diagram of an authorization interface 3313. The electrical appliance administration system 3 is derived from the electrical appliance administration system 2. The electrical appliance administration system 3 further includes another portable electronic device (in the following referred to as secondary portable electronic device 13′). And, the power management program 331 of the electrical appliance administration system 3 includes an authorization interface 3313. In addition, the secondary portable electronic device 13′ includes a secondary power management program 331′. The secondary power management program 331′ includes a display interface 2310′. The display interface 2310′also includes a power control switch 2311′. Furthermore, the secondary power management program 331′is configured to save a piece of identity information 3312′. The identity information 3312′ for example is personal mobile phone number or personal E-mail address. Please refer FIG. 9 again, the authorization interface 3313 is inputted with the identity information 3312′ by the user with the portable electronic device 13, the power data 91 of cloud server 12 would be downloaded to the secondary power management program 331′. The power control switch 2311′ of the secondary power management program 331′ could also administer the operation of the electrical appliance 9. As a result, other users could get the power data 91 of the electrical appliance 9 and administer the electrical appliance 9.

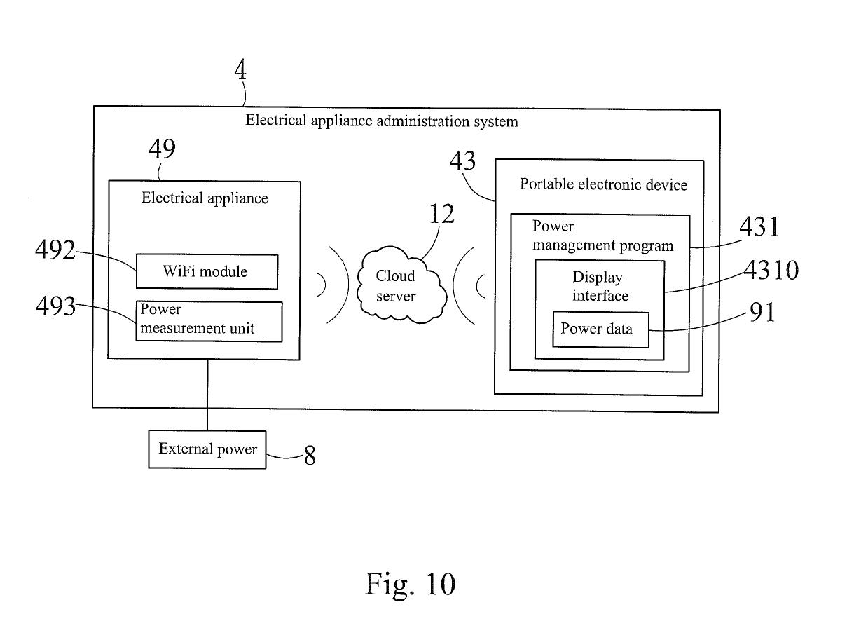

Please refer FIG. 10. FIG. 10 illustrates a block diagram of the electrical appliance administration system 4 in accordance with another embodiment of the present invention. The electrical appliance administration system 4 includes at least one electrical appliance 49, a cloud server 12, and a portable electronic device 43. The electrical appliance 49 includes a Wi-Fi module and a power measurement unit. The electrical appliance 49 is configured to receive a power provide by an external power 8. Moreover, the power measurement unit 493 is configured to detect a power data 91 of the electrical appliance 49. The power data 91 for example is a value of an electric power (the unit of the electric power is watt). Afterward, the Wi-Fi module 492 of the power control device 49 is configured to transmit the power data 91 to the cloud server 12. Furthermore, the portable electronic device 43 includes a power management program 431. The power management program 431 includes a display interface 4310. When the power management program 431 is operated, the portable electronic device 43 is connected to the cloud server 12, and the power data 91 would be downloaded to the power management program 431. Afterward, the power data 91 would be displayed on the display interface 4310. As a result, when the electrical appliance 49 is being used, the electrical appliance administration system 4 would make the user with the portable electronic device 43 get the value of the electric power of the electrical appliance 49.

When the power data 91 is received by the cloud server 12, a first notification message is transmitted to the portable electronic device 43 by the cloud server 12. As a result, when the electrical appliance 9 in the house is turned on for no reason, the user with the portable electronic device 43 could perceive that at the first time and increase the safety of using the electrical appliance 9 in the house. Furthermore, when the value of the electric power received by the cloud server 12 is more than a wattage value (e.g., the wattage value is 1000 W), the cloud server 12 would transmit a second notification message to the portable electronic device 43 (not illustrated). As a result, the portable electronic device 13 also reminds the user to pay attention to the high-wattage the electrical appliance 49 being used.

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

What is claimed is:

1. An electrical appliance administration system comprising:
at least one power control device connected to an electrical appliance and receiving a power provided by an external power, the power control device transmitting the power to the electrical appliance, the power control device comprising a power measurement unit, and the power measurement unit detecting a power data of the electrical appliance;
a cloud server, wherein the power control device transmits the power data to the cloud server;
a portable electronic device comprising a power management program, the power management program comprising a display interface;
wherein when the power management program is operated, the portable electronic device is connected to the cloud server, and the power data would be downloaded to the power management program.

2. The electrical appliance administration system of claim 1, wherein the power control device includes a control module and the control module can turn on and turn off the power control device.

3. The electrical appliance administration system of claim 2, wherein the display interface includes a power control switch; when the control switch is turned off, the power management program transmits a turn off-control signal to the cloud server, the cloud server transmits the turn off-control signal to the power control device, and the control module turns off the power control device depending on the turn off-control signal.

4. The electrical appliance administration system of claim 1, wherein when the cloud server receives the power data, the cloud would transmit a first notification message to the portable electronic device.

5. The electrical appliance administration system of claim 1, wherein the power data is a value of an electric power.

6. The electrical appliance administration system of claim 5, wherein when the value of the electric power received by the cloud server is more than a wattage value, the cloud server would transmit a second notification message to the portable electronic device.

7. The electrical appliance administration system of claim 1, wherein the power control device is a smart plug.

8. The electrical appliance administration system of claim 1, wherein the portable electronic device is a smart phone or a tablet PC.

9. The electrical appliance administration system of claim 1, further comprising a secondary portable electronic device, the secondary portable electronic device comprising a secondary power management program, the secondary power management program saving a piece of identity information, and the power management program comprising an authorization interface; wherein when the authorization interface is inputted with the identity information, the power data of cloud server would be downloaded to the secondary power management program.

10. The electrical appliance administration system of claim 9, wherein the identity information is personal mobile phone number or personal E-mail address.

11. An electrical appliance administration system comprising:
at least one electrical appliance comprising a power measurement unit and a Wi-Fi module, and the power measurement unit detecting a power data of the electrical appliance;
a cloud server, wherein the Wi-Fi module wirelessly transmits the power data to the cloud server;
a portable electronic device comprising a power management program, the power management program comprising a display interface;
wherein when the power management program is operated, the portable electronic device is connected to the cloud server, and the power data would be downloaded to the power management program.

12. The electrical appliance administration system of claim 11, wherein when the cloud server receives the power data, the cloud would transmit a first notification message to the portable electronic device.

13. The electrical appliance administration system of claim 11, wherein when the value of the electric power received by the cloud server is more than a wattage value, the cloud server would transmit a second notification message to the portable electronic device.
